(19) United States
(12) Patent Application Publication
(10) Pub. No.: US 2023/0351526 A1
(43) Pub. Date: Nov. 2, 2023

(54) METHOD AND SYSTEM FOR SENTIMENT ANALYSIS

(71) Applicant: ADVANCED SYMBOLICS (2015) INC., Ottawa (CA)

(72) Inventors: John Kenton WHITE, Ottawa (CA); Shainen DAVIDSON, Ottawa (CA)

(73) Assignee: ADVANCED SYMBOLICS (2015) INC., Ottawa, ON (CA)

(21) Appl. No.: 18/140,860

(22) Filed: Apr. 28, 2023

Related U.S. Application Data
(60) Provisional application No. 63/335,760, filed on Apr. 28, 2022.

(51) Int. Cl. G06Q 50/00

(52) U.S. Cl. CPC G06Q 50/01

(57) ABSTRACT

A method is disclosed wherein a social media feed is provided comprising messages related to communication about topics, the communication about the topics linked in a structure for forming a conversation. The social media feed is clustered to identify messages within the social media feed that are related one to another to form clusters of the messages. Sets of partisans are provided relating to a first cluster from the clusters of the messages. Then, for the first cluster, a ratio of messages transmitted by each of the at least two sets of partisans is determined and the ratio indicates a winner of the first cluster. Based on the winner and a ratio of non-partisan actors who transmitted messages within the first cluster, an effect of the first cluster upon sentiment of a population is measured.

### FIELD OF THE INVENTION

The invention relates to sentiment analysis and more particularly to automating sentiment analysis based on a priori information.

### BACKGROUND

In many fields, consumer sentiment is an important measure for making decisions. If one knew exactly how and what everyone was thinking, it would make politics easier, product design easier, advertising easier, etc. The problem lies in the fact that people are complex, and extrapolating answers from a few questions asked of a few people rarely leads to repeatable and actionable results.

To this end, a first area of statistics focuses on determining a perfect sample group for representing a population. A second area of statistics focuses on questionnaires and designing them to hide their purpose while extracting real, valid, and uninfluenced feedback. When a well-designed questionnaire is asked of a statistically valid group of individuals, a result of analysis of the questionnaire responses in aggregate allows for a prediction with approximately known accuracy of an opinion of a large group of people. Thus, in the weeks leading up to an election, people are repeatedly subjected to poll results aiming to tell them what or whom the general public is supporting.

Commercial companies also rely on sentiment data to craft public statements and to evaluate results of advertising and product formulations. A company, such as Audi® might rely more on sentiment data in crafting a response to an article that says their cars suddenly accelerate, than to the engineering reality that statistically accidents are caused by human error. Though the latter may eventually become the common truth, during the initial stages, responding to the public sentiment appears more important than being “right.”

People make careers out of both measuring public sentiment and out of crafting responses to public sentiment. When reputation responses are formulated, they can be tested against the public by, again, measuring the sentiment data in response to the reputation response —did the reputation response achieve its goal.

To this end, there is a field devoted to sentiment analysis in natural language processing. In this field, language is evaluated to detect indications of sentiment and then writings are binned into their appropriate estimated sentiment group; each group has a range of sentiment common to the group. For example, an article is grouped into one of five groups—strongly against, against, neutral, agree, and strongly agree. Even though natural language processing may be flawed, when it is sufficiently accurate and errors are sufficiently random, the resulting groupings provide a good indication of the sentiment found in the writings. This field of study, for example, is used to analyse news sources to determine bias. Though bias is a purely subjective measure, relative bias is objectively determinable. One may not know whether something is true or not through semantic analysis and, as such, a piece supporting a right-wing politician will be seen as right-leaning even if it is “honest” and therefore unbiased. That said, an article panning the right-wing politician relying on a same set of facts will be seen as more left-leaning than the first article. Thus, though objective “unbiased” may remain unknown, articles can be mapped on a spectrum one relative to the other and relative to a population.

This area of study has been found to have significant advantages when applied to essays or newspaper articles, each of which provides enough writing to be analysed. Similarly, as the writing quantity is reduced, often-times there are greater indications of bias such as fantastically biased headlines. These headlines themselves are often designed to be biased and to show bias. In the world of professional writing, being grouped with an accurate bias level helps that writing find its audience.

Unfortunately, when semantic analysis is applied to very short statements such as those present in twitter feeds, comment feeds, feedback, and other social media posts, a breakdown in the processes occurs, because there is a lack of sufficient grammatical structure and words to accurately determine bias. Filtering of all messages wherein bias is indeterminate, may result in the true bias of, for example, a Twitter feed being incorrectly determined. Further, as the group itself is not determined to be statistically valid for extrapolation to the population, the filtering of messages based on length or grammar therein may effectively introduce a filtering bias or may limit the resulting group to a poorly representative group for the overall population being analysed. Finally, any such filtering effectively effects the cross sectional makeup of the group preventing representative groups from being sampled after selection.

Application of semantic analysis to social media feeds requires a lot more research of social media feeds and research into the effects of the limitations of semantic analysis. Though these areas of research are rapidly advancing, a simpler solution to analysing feed contents and bias would be useful.

It would be advantageous to provide reliable sentiment data more rapidly and more broadly without any need to design complex questionnaires, identify polling groups and then analyse questionnaire results.

### SUMMARY

In accordance with an embodiment there is provided a method comprising: providing a social media feed comprising messages related to communication about topics, the communication about the topics linked in a structure for forming a conversation; clustering the social media feed to identify messages within the social media feed that are related one to another to form clusters of the messages; providing at least two sets of partisans relating to a first cluster from the clusters of the messages; for the first cluster, determining a ratio of messages transmitted by each of the at least two sets of partisans, the ratio determining a winner of the first cluster; evaluating a ratio of non-partisan actors who transmitted messages within the first cluster; and based on the non-partisan actors, determining an effect of the firs tcluster upon sentiment of a population.

In accordance with an embodiment there is provided a system comprising: a network of computers in digital communication one with another; at least a server for hosting a social media feed comprising messages related to communication about topics, the communication about the topics linked in a structure for forming a conversation; a sentiment analyser comprising a processor and memory for receiving at least two sets of partisans relating to a first cluster; clustering the social media feed to identify messages within the social media feed that are related one to another to form clusters of the messages, the clusters of the messages including the first cluster; determining for the first cluster a ratio of messages transmitted by each of the at least two sets of partisans, the ratio determining a winner of the first cluster; evaluating a ratio of non-partisan actors who transmitted messages within the first cluster; and determining based on the non-partisan actors an effect of the first cluster upon sentiment of a population.

### DRAWINGS

Exemplary embodiments of the invention will now be described in conjunction with the following drawings, wherein similar reference numerals denote similar elements throughout the several views, in which:

FIG. 1 is a simplified flow diagram of a polling process;

FIG. 2 is a simplified flow diagram of a process for performing of semantic analysis to replace polling;

FIG. 3 is a simplified flow diagram of a method of performing semantic analysis according to an embodiment;

FIG. 4 is a simplified flow diagram of a method of performing sentiment analysis based on a priori information;

FIG. 5 is a simplified flow diagram of analysis of a social network data feed;

FIG. 6 is a simplified flow diagram of a process for filtering tweets into clusters, “conversations;” and

FIG. 7 is a simplified flow diagram of an hierarchical clustering for use in sentiment analysis according to an embodiment.

### DETAILED DESCRIPTION OF EMBODIMENTS

The following description is presented to enable a person skilled in the art to make and use the invention and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed but is to be accorded the widest scope consistent with the principles and features disclosed herein.

### Definitions

Within the present application and the claims that follow, the following definitions are used.

“Sentiment Analysis” is a process by which a bias of an individual, group or a population is determined through processing of data by a computer system relying on statistical methods.

“Social Media” is a data structure comprising nodes representative of individuals and connections between nodes representative of connections between those individuals, the connections reflective of relationships, for example but not limited to common interests, friendship, social interaction, or monitoring/following.

“Twitter® Like Feed” is a stream of short text messages from many individuals organised into a structure of messages including replies to messages, re-messaging of messages, and conversations about messages, all messages having a short format.

“Partisans” are individuals who are known to have a viewpoint biased toward an entity to which they are partisan.

“Partisan actors” are individuals who behave as partisans. Some partisan actors are partisans while others behave as partisans within specific contexts or for periods of time.

“Non-partisans,” “Non-partisan actors,” “Non-partisan users” individuals within a set that are not within a group defined as partisans or partisan actors or partisan users for a given context. In different sets, different users may be partisan such that a partisan user within a single context, for example politics, may be a non-partisan in another context, for example vaccine efficacy.

“Number of non-partisan users” is a number of individuals within a conversation that are not within a group defined as partisans for that conversation.

“General issue” is an issue facing a population that is being evaluated through sentiment analysis. For example, the general issue of political party support is evaluated with specific issues and sentiment analysis revolving around those specific issues.

“Fits” a cluster fits within a general issue when the cluster effects a measured result forming part of the general issue. For example, a cluster fits the general issue of political party support when the cluster relates to a single issue, for example, that may effect overall voter support for a party.

The holy grail of sentiment analysis is directly linking events to their consequences. It would be highly desirable to link a first event to a second event. For example, in politics it would be valuable to link an announcement to a reaction.

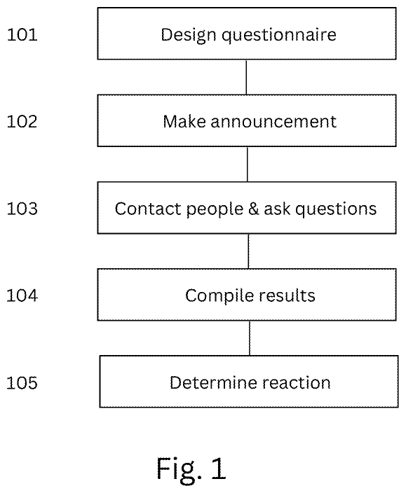

Referring to FIG. 1, shown is a simplified flow diagram of a polling process. At 101, a questionnaire is designed to try to elicit information that is sought. Though questionnaires are complex, specialists can often design questionnaires for their intended purpose. At 102 an announcement is made. The announcement is made to the press to try to ensure that it is disseminated to the public. Either the next day or some time later, at 103 each of a plurality of identified individuals is contacted to answer the questionnaire. Once each individual has answered the questionnaire, the results are compiled at 104 and an estimation of the reaction to the announcement is determined at 105.

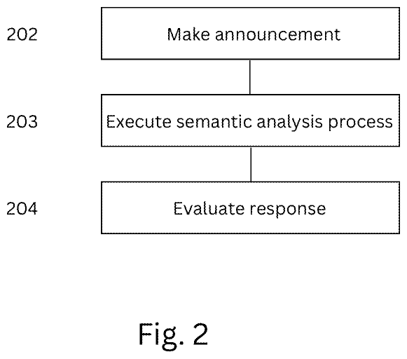

Referring to FIG. 2, shown is a simplified flow diagram of a method of using semantic analysis to determine a consequence of an event. At 202, an announcement is made. The announcement is made to the press to try to ensure that it is disseminated to the public. Immediately after the release of the announcement, at 203, a semantic analysis process in execution on a wide area network in the form of the Internet to analyse news stories to determine a general response within media and editorials. The response is evaluated against a desired response at 204.

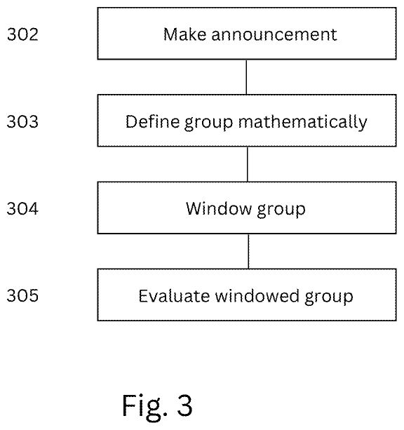

Referring to FIG. 3, shown is an embodiment for evaluating a response to an event according to an embodiment. At 302, an announcement is made. The announcement is made via social media in the form of Twitter®. In dependence upon the announcement, a community forms. For example, the community includes people who have retweeted the announcement, have commented on the announcement, etc. The group is mathematically defined as a first set at 303. At 304, the set is windowed so that it relates to a specific time frame and/or other definable parameters. For example, the set is windowed to define a length of time that is a day at one-hour intervals.

At 305, the windowed set is evaluated to determine a sentiment therein. The sentiment analysis is performed based on a priori information instead of based on analysis of message content. This obviates a need to try to understand very short messages and their sentiment.

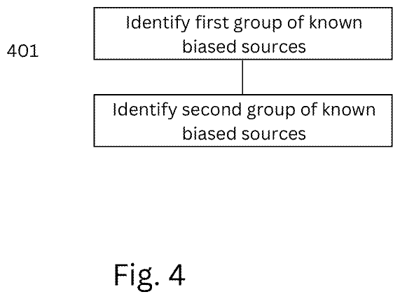

Referring to FIG. 4, shown is a simplified flow diagram of a method of performing sentiment analysis based on a priori information. At 401, a first group of known biased sources of information are identified. For example, official company sources for company A are identified as are contractors working for company A. In some embodiments, known supporters of Company A are also included in the group. Ideally, the first group represents a majority of individuals or accounts significantly biased toward Company A. At 402, a second group of known biased sources of information are identified. For example, official company sources for company B, a competitor to Company A in relation to the announcement, are identified as are contractors working for company B. In some embodiments, known supporters of Company B on issues or content of the announcement are also included in the group. Ideally, the second group represents a majority of individuals or accounts significantly biased toward Company B.

By evaluating a proportion of tweets from the first group vis a vis the second group within the set, it is possible to determine a bias of a given set. The bias is assumed because likely for a given announcement, more people supportive of the comment will retweet it and be part of a conversation. Thus, the set is seen as representing the ratio between the first group and the second group for a population size within the set. As it is unlikely that those with a strong bias will be swayed by an announcement, those whose bias is known a priori are optionally subtracted from the set of users. This leaves a number of users potentially swayed assessable based on a response the announcement and involvement in the set.

In another example, a sentiment analysis of a political announcement is measured. Here, it is determined that a plurality of entities highly biased toward a particular political party. For example in Canada, there are three major parties and those entities aligning with each party such as each party, the candidates within each party, the provisional branches of the same parties, previous candidates from each party, etc. are all known to support announcements from said party or benefiting said party. Thus, three groups are known to be highly supportive of their respective parties. These three groups are known and it is known that each group should be involved in each conversation about each politically relevant event and each announcement released on twitter, when the politically relevant event or announcement reflects a positive statement for their party or a negative statement for another party. Thus, an announcement that Party A has accomplished something positive should be retweeted by the known supporters of party A. A tweet that is harmful to party A would likely be retweeted by known supporters of parties B and C. Of course this can be extrapolated to any number of political parties.

A tweet is issued beginning a conversation. The conversation forms a set. Alternatively, the conversation is windowed, divided into subsets of a length of time or number of tweets or divided into a plurality of subsets. The set is then analysed to determine a bias of the conversation based on the known three groups and their members. If one party is mostly represented, then the conversation favours that party. If two parties of the three parties are mostly represented then the conversation favours both those parties. Often, an announcement is most advantageous to one perspective and therefore is dominated by a single party. For multiparty systems having more parties, the parties biased toward the announcement are somewhat distinguishable from parties biased against the announcement.

By determining within the known groups a dominant group within a conversation, the bias of the conversation is determined. The number of individuals within the conversation then indicates an impact of the conversation in a direction toward the bias. Conversations that see very little ‘action,’ few individuals outside the known groups participating, are likely to have little to no influence on sentiment. Conversations that are widely distributed and retweeted are likely to reflect more public interest and greater influence.

As a result, larger conversations having greater influence can be compiled into a list and candidates can view which issues and/or presentation of issues had a greatest impact on voters and which ones most improved their position. This allows for refinement of political positioning during a campaign. In a two-party system, such a process can identify “key” issues. In a multiparty system having many parties, such a process allows for fine tuning of political positioning of each party.

In some embodiments, it is important to determine a lifespan of an issue. In those situations, a first statement about the issue is made. The results are measured. Later, a further statement is made, for or against the issue, and results are again measured. By evaluating a difference between the first response and the second response, it is possible to evaluate a change in the influence of the statement over time. Changes can be measured over and over to determine changes over time, or one or more changes are measured and the changes are then mapped onto known change curves to select a most likely change in response over time.

In another embodiment, the group of individuals with known bias is determined automatically by analysing positions of individuals on different known issues to see alignment of those individuals. For example, on a politically charged issue, positions of people can be measured to group them in the context of that issue. Of course, grouping of people based on common bias is also possible, even without knowledge of context.

In another embodiment, the group of individuals is manually curated. In yet a further embodiment, the group is manually curated at a first time and then updated automatically based on a bias of individuals within conversations over time and a consistency thereof. Individuals who always participate in conversations heavily biased to one party are added to the group of individuals biased toward that party—partisan users. In this way, the known groups adapt and change as individuals line up with party positions.

A larger group of known biased individuals typically produces better statistical results. For example, by correcting for some known biased individuals being more or less biased on some issues. Small conversations that are below a threshold are likely mostly related to biased known individuals and are of little interest to the public and, due to their size, are typically shown to have minimal impact on the population.

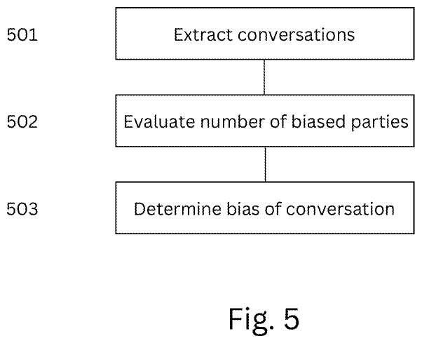

Referring to FIG. 5, shown is a simplified flow diagram of an example of mathematical analysis of a social network data feed. For a set of tweets related to a political party and first date or range of dates, “conversations” are extracted at 501, i.e. clusters of tweets with similar text. Within each cluster, a number of tweets by known biased parties, partisans, is evaluated at 502 and used at 503 to determine whether said cluster is biased positively or negatively for the political party—is this cluster of tweets representing one party “winning” an aspect of an issue. When the political party has “won” this conversation, the political party gains net public opinion proportional to the number of non-partisan users engaged in the conversation, at the expense of another party; this assumes that public opinion is a zero-sum game. As parties are only interested in their relative standing, one relative to another, this is likely a good model. When the political party has “lost” this conversation, the political party loses net public opinion proportional to the number of non-partisan users engaged in the conversation, to the benefit of another party

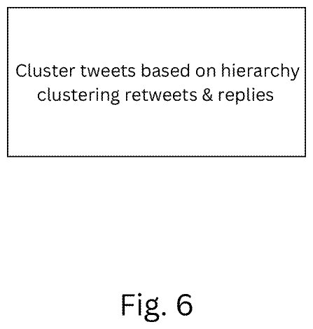

Referring to FIG. 6, shown is a simplified flow diagram of a process for filtering tweets into clusters, “conversations.” Clustering involves the clustering or grouping of any pre- processed text in an unsupervised manner. A number of clusters or themes is unknown and varies from one dataset to another; therefore traditional supervised learning methods are not be applied in this embodiment. A supervised process is tailored to a specialised dataset, whereas an unsupervised one is good at approximating and extrapolating on unseen data.

Most clustering methods involve a first step to define a mathematical framework for objects to be clustered, in this example text, and second to define a criteria—a measurement of distance, how are two tweets seen to be close or distant. Once this framework is defined, measuring distance between tweets and clustering those that are close enough, where distance is below a threshold distance, is repeatable.

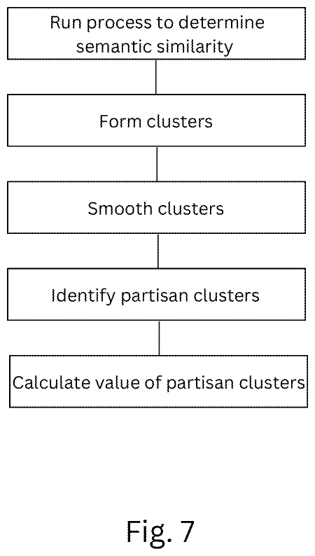

In an embodiment, a hierarchical clustering process is employed as shown in FIG. 7 that first runs deep bidirectional transformers for language understanding vectorizer, BERT, as described by Devlin, Chang, Lee and Toutanova in 2018 on the preprocessed text and converts it into vectors. Semantic similarity is computed on these vectors by doing a dot product on the matrices.

Then in the first pass of clustering, vectors are grouped based on semantic similarity distances into approximate clusters. This first pass results in a significantly unbalanced distribution of elements where cluster sizes vary vastly and there is considerable overlap between different clusters. Hence, subsequent passes are employed to iteratively smooth cluster distribution. During subsequent passes elements in a boundary region within a cluster are candidates for reallocation to a cluster or to another cluster. Since this is a density-based scan, there are often unclustered elements indicated within a list of elements that do not fall in any cluster.

Since the described density-based hierarchical clustering process does not take cluster number as an input value, there is no implicit control on size of clusters formed. To enable some control over cluster size and number, a “cluster resolution” parameter is introduced that varies from 1 to 4. At 1, the process forms a few big clusters, and at 4 the process forms many finer clusters. Some tweets which do not meet any clustering condition remain unclustered; an amount of unclustered tweets will vary by resolution.

In order to maximise a number of clusters that can be clearly labelled as representing a viewpoint of one group relative to another, i.e. the majority of partisans are of a single group, in some embodiments a number of clusters meeting that criteria is calculated and the “cluster resolution” parameter is adjusted. For example, the “cluster resolution” parameter is adjusted to maximise a number of clusters that have a single party with over 50% of identified partisan tweets. In some embodiments, different clustering goals are supported.

Within each cluster, a number of non-partisan users who engage in topics of influence for each party is used as a proxy for how public opinion has changed for that party. A positive influence is seen as positive change and a negative influence is seen as negative change. A number of non-partisan users is indicative of an overall change in public opinion.

For example, for each cluster of tweets, a ratio between tweets from partisans of different groups is calculated, where NP=p is the number of tweets of party p in the cluster. For clusters where RP=p>0.5, the cluster is considered to be a conversation “won” by party p. This threshold allows only one party (or none) to be the winner. Alternatively, a different threshold above 0.5 is used to determine a winner where in a winner only exists if it has surpassed the different threshold.

The value of a cluster, how much an effect it should have on public opinion, is related to a number of users who are not partisan over a total number of users. Scaling adjusts a measure of influence to engagement to ensure that days with different numbers of overall users are not over weighted.

When overall effect is sought, the value of the conversation is added to a total for the “winning” party, while the value of the conversation is subtracted from the total for the party whom the conversation adversely affects. Thus the change in conversation is a zero-sum game among the parties. Conversations “won” by a party about itself is filtered so that it is not measured as effecting public opinion. Alternatively, all conversations are included in calculating results.

Change in opinion as calculated above has no meaningful scale. Since it is only a measure of change or opinion, there is no information on the opinion baseline to deviate from. The unit of the change is a ratio—non-partisan users/total users per day in conversations relating to a same influence on the population, so a scaling factor is applied to convert the data to a form that is meaningful when desired. Meaningful forms are, for example, percentage of people, number of people, dollars, etc. A company, may seek to see how many new customers it has garnered. Alternatively, it may seek a data form that indicates additional profits or potential losses. A politician is most interested in percentages relating to popular support. Other organisations may have other meaningful indicators.

Advantageously, it is unimportant to know the content of the conversations within a cluster other than the basic information that it is supportive of the “winner” or negative to a non-winner. Beyond that, it is the dominance of one known group of partisan actors that determines a conversations bias and a number of non-partisan actors that determines its effects.

In some embodiments, filtering of clusters to remove unreliable data such as data injected into a stream by bots or other artificial users is performed.

In some embodiments, windowing is performed to see a bias in a cluster and how it changes over time. This allows for measurement of responses to events over time when tracking of conversations is significant. In many fields, there are so many clusters and so many changes each day that following a single cluster over time is unnecessary.

In some embodiments a conversation is attributed to a particular position manually. In other embodiments, the entire conversation is evaluated to automatically determine its position. In yet other embodiments, a conversation and its bias are used to determine automatically a position of the conversation. In yet a further embodiment, initial messages, tweets, within a conversation are used in conjunction with the overall bias of said conversation to automatically determine a position of the conversation. For example, a most common tweet or very common tweet is used as a baseline for the reporting such that Tweet A stated X and is indicative of a 2% swing in votes from this political party to that political party can be a fully automated result without any comprehension of what Tweet A actually states.

To determine a group of biased individuals, analysis is performed of at least one of affiliation, social connection, and behaviour. It is very likely that the Young Republicans support the Republican party as they are affiliated. Further, the individuals that they follow on social media also lean heavily to the right. Finally, their historical behaviour, both in action and in social media posting are also heavily aligned with the Republican party. Any one of these indicia is often sufficient to indicate bias. In an embodiment, a list of social connections of each individual is relied upon to determine their bias. When an individual has a proportion of their connections with a given bias that is over a selected threshold, then that individual is determined to be biased with the given bias. An individual who follows 100 right leaning pundits and 4 left leaning pundits is likely biased toward the right. Of course, for many organisations, it is a priori known that they are biased and how. As indicated above, the Republican party, the Republican candidates, former Republican candidates, and right-wing media outlets are all known to be biased to the right. For political sentient analysis, entering all of these as defacto biased individuals aids the system, provides a seed, in both extrapolation of the group of biased individuals and in simplifying a determination of other biased individuals. In some embodiments, manually confirmed partisans are weighted more heavily than those automatically determined by the system. As an example, the republican party being followed may be weighted more significantly than someone who follows right-wing partisans who is automatically determined to be included in the group of biased individuals by the process. In such a manner, manual confirmation of biased individuals maintains a common seed for determining groups of biased individuals, even in the face of changing biases.

Numerous other embodiments may be envisaged without departing from the scope of the invention.

What is claimed is:

1. A method comprising:
providing a social media feed comprising messages related to communication about topics, the communication about the topics linked in a structure for forming a conversation;
clustering the social media feed to identify messages within the social media feed that are related one to another to form clusters of the messages;
providing at least two sets of partisans relating to a first cluster from the clusters of the messages;
for the first cluster, determining a ratio of messages transmitted by each of the at least two sets of partisans, the ratio determining a winner of the first cluster;
evaluating a ratio of non-partisan actors who transmitted messages within the first cluster; and
based on the non-partisan actors, determining an effect of the first cluster upon sentiment of a population.

2. A method according to claim 1, wherein an effect of the cluster is determined to be negligible if a sentiment of the first cluster is for a first partisan and wherein conversation within the first cluster is also for the first partisan.

3. A method according to claim 2, wherein an effect of the cluster is determined to be a ratio of non-partisan actors who transmitted messages within the first cluster over non-partisan actors who transmitted messages within any cluster relating to a general issue within which the first cluster fits and being evaluated for the population.

4. A method according to claim 1, wherein an effect of the cluster is determined to be a ratio of non-partisan actors who transmitted messages within the first cluster over non-partisan actors who transmitted messages within any cluster relating to a general issue within which the first cluster fits and facing the population.

5. A method according to claim 1, wherein providing at least two sets of partisans comprises:
providing a list of known partisans supporting a topic within the first cluster; and
providing a list of known partisans opposing a topic within the first cluster.

6. A method according to claim 5 comprising:
based on the provided list of known partisans supporting a topic, determining other partisans supporting the topic; and
based on the provided list of known partisans opposing a topic, determining other partisans opposing the topic.

7. A method according to claim 1 wherein clusters are determined in reliance upon an unsupervised process.

8. A method according to claim 7 wherein the unsupervised process comprises:
performing vectorization with deep bidirectional transformers for language understanding to provide first vectors;
determining initial clusters based on distances between the first vectors; and
smoothing the initial clusters to form the clusters of the messages.

9. A method according to claim 1 wherein the ratio is evaluated in accordance with the following: (a number of partisans from a first set of the at least two sets of partisans): (a number of partisans from a second other set of the at least two sets of partisans).

10. A method according to claim 1 wherein the ratio is evaluated in accordance with the following: (a number of partisans from a first set of the at least two sets of partisans that are participants in the first cluster/a total number of partisans from the first set of the at least two sets of partisans): (a number of partisans from a second other set of the at least two sets of partisans that are participants in the first cluster/a total number of partisans from the second other set of the at least two sets of partisans).

11. A system comprising:
a network of computers in digital communication one with another;
at least a server for hosting a social media feed comprising messages related to communication about topics, the communication about the topics linked in a structure for forming a conversation;
a sentiment analyser comprising a processor and memory for receiving at least two sets of partisans relating to a first cluster;
clustering the social media feed to identify messages within the social media feed that are related one to another to form clusters of the messages, the clusters of the messages including the first cluster;
determining for the first cluster a ratio of messages transmitted by each of the at least two sets of partisans, the ratio determining a winner of the first cluster;
evaluating a ratio of non-partisan actors who transmitted messages within the first cluster; and
determining based on the non-partisan actors an effect of the first cluster upon sentiment of a population.

12. A system according to claim 11 wherein the effect comprises a quantity and a direction, the system comprising a display for displaying the effect.

13. A system according to claim 11 wherein the effect comprises a quantity and a direction, the system comprising:
a suitable programmed processor for summing the effect with other determined effects to form an aggregate effect; and
a display for displaying the aggregate effect.
